(19) United States
(12) Patent Application Publication
(10) Pub. No.: US 2025/0348683 A1
(43) Pub. Date: Nov. 13, 2025

(54) Multimodal Conversational Artificial Intelligence Architecture and Design

(71) Applicant: Steven Deeb, Dallas, TX (US)

(72) Inventor: Steven Deeb, Dallas, TX (US)

(21) Appl. No.: 19/201,168

(22) Filed: May 7, 2025

Related U.S. Application Data
(60) Provisional application No. 63/643,577, filed on May 7, 2024.

(51) Int. Cl. G06F 40/35; G06F 40/289; H04L 65/1069

(52) U.S. Cl. CPC G06F 40/35; G06F 40/289; H04L 65/1069

(57) ABSTRACT

An immersive multimodal conversational AI system for providing contextually aware, human-like multimodal conversations and method of use. The system includes a plurality of input interfaces configured to receive a corresponding plurality of modalities of user input. The system also includes a plurality of output interfaces configured to deliver a corresponding plurality of modalities of generated output to the user. The system also includes a memory storing user input, generated output, and instructions. A processor communicatively coupled to the input interfaces, output interfaces, and memory executes the instructions to process the plurality of modalities of user input and dynamically generate, in real-time, an immersive contextually-aware multimodal response comprising the plurality of modalities of generated output.

### RELATED APPLICATIONS

The present disclosure claims priority to U.S. Provisional Patent Application Ser. No. 63/643,577, filed May 7, 2024, the entirety of which is incorporated herein by reference for all purposes.

### TECHNICAL FIELD

The present disclosure relates in general to the field of conversational artificial intelligence (AI), and more particularly to a novel multimodal conversational AI system for providing improved conversations with users, as well as methods of use.

### BACKGROUND

Conversational AI systems enable computers to simulate human-like conversations. This type of AI may leverage natural language processing (NLP) and machine learning to understand, process, and respond to human speech or text. Conversational AI systems can typically handle simple, turned-based interactions, often focusing on a single modality, typically audio or text, and handling synchronous user input. Additionally, typical conversational AI systems are unable to handle unexpected user input, fractured user input, or deviations from a pre-defined dialog flow. Furthermore, typical conversational AI systems struggle to maintain context across longer conversations or between topics. Accordingly, typical conversational AI system cannot provide seamless, human-like conversations, particularly when handling complex or multi-faceted interactions.

What is needed in the art is an improved multimodal conversational AI that can facilitate unified, comprehensive, and adaptive human-like conversations with users across multiple modalities.

### SUMMARY

Novel aspects of the present disclosure are directed to a multimodal conversational AI system comprising a plurality of input interfaces configured to receive a corresponding plurality of modalities of user input and a plurality of output interfaces configured to deliver a corresponding plurality of modalities of generated output to the user. The system also comprises a memory storing user input, generated output, and instruction. The system also comprises a processor communicatively coupled to the plurality of input interfaces, the plurality of output interfaces, and the memory, wherein the processor is configured to execute the instruction to process the plurality of modalities of user input and generate a contextually-aware immersive multimodal response comprising the plurality of modalities of generated output.

In another embodiment, novel aspects of the disclosed principles are directed to a method of operating a multimodal conversational AI system, comprising defining, with a dialog management module, a plurality of topics and associated dialog flows; establishing, using the session manager, a user session; initiating a conversation with the user with the session manager; receiving, by the user interface, a plurality of modalities of user input; processing, with an input processing module comprising one or more computing processors, the plurality of modalities of user input; updating, with the context management module, a unified conversation context based on each processed user input; generating, with the multimodal response generator, at least one multimodal response tailored to at least one of a plurality of output modalities; and delivering each multimodal response to the user via a plurality of modalities of output.

Other aspects, embodiments, and features of the disclosed principles will become apparent from the following detailed description when considered together with the accompanying figures. In the figures, each identical or substantially similar component that is illustrated in various figures is represented by a single numeral or notation. For the purposes of clarity, not every component is labeled in every figure. Nor is every component of each embodiment of the disclosed principles shown where illustration is not necessary to allow those of ordinary skill in the art to understand the principles disclosed herein.

### BRIEF DESCRIPTION OF THE DRAWINGS

The novel features believed characteristic of the disclosure are set forth in the appended claims. The disclosure itself, however, as well as a preferred mode of use, further objectives, and advantages thereof, will be best understood by reference to the following detailed description of illustrative embodiments when read in conjunction with the accompanying drawings, in which:

FIG. 1 illustrates a schematic of one embodiment of a multimodal conversational AI system designed and constructed in accordance with the disclosed principles;

FIG. 2 illustrates a block diagram of a multimodal conversational AI system;

FIGS. 3A-3B illustrate a schematic diagram of one embodiment of a multimodal conversational AI system as disclosed herein;

FIG. 4 illustrates a flowchart of one embodiment of a process for operating a multimodal conversational AI system as disclosed herein;

FIG. 5 illustrates an exemplary multimodal conversation between a user and the multimodal conversational AI system as disclosed herein;

FIG. 6 illustrates another exemplary multimodal conversation between a user and the multimodal conversational AI system as disclosed herein; and

FIGS. 7A-7C illustrate another exemplary multimodal conversation between a user and the multimodal conversational AI system as disclosed herein.

### INDEX OF REFERENCE NUMERALS AND DEFINITIONS

| Reference | Element |
|---|---|
| 100 | Multimodal conversational AI system |
| 102 | User interface |
| 102a | Input interface |
| 102b | Output interface |
| 104 | Call management platform |
| 106 | Control center |
| 108 | Session manager |
| 110 | Agent circuit |
| 110a | Prompt driver agent |
| 110b | Response agent |
| 110c | Specialized agent |
| 200 | Computing device |
| 202 | Processor |
| 204 | Input/Output device |
| 206 | Memory |
| 302 | Modality focus listener |
| 304 | Context management module |
| 306 | Input processing module |
| 308 | Natural language processing engine |
| 310 | Dialog management module |
| 312 | Multimodal response generator |
| 400 | Flowchart |
| 402 | Step 402 |
| 404 | Step 404 |
| 406 | Step 406 |
| 408 | Step 408 |
| 410 | Step 410 |
| 412 | Step 412 |
| 414 | Step 414 |
| 500 | Exemplary multimodal conversation |
| 502 | User audio input |
| 504 | User interface |
| 600 | Exemplary multimodal conversation |
| 602 | Visual output |
| 604 | User audio input |
| 606 | Audio output |
| 700 | Exemplary multimodal conversation |
| 702 | Visual output |
| 704 | User audio input |
| 706 | Audio output |

### DETAILED DESCRIPTION

Novel aspects of this disclosure recognize the need for an improved conversational AI system. To this end, an immersive multimodal conversational AI system is provided that can facilitate unified and comprehensive human-like conversations with a user across multiple modalities. The multimodal conversational AI system is designed to provide a more natural, flexible, and contextually aware user experience. Unlike traditional conversational AI systems with rigid dialog flows and limited modality support, the multimodal conversational AI system disclosed herein addresses the challenges of fragmented user input, asynchronous communication, and seamless context transfer across diverse modalities. The multimodal conversational AI system provides a comprehensive approach to user interaction, integrating audio and visual elements. Through AI-powered control codes, synchronized interfaces, and interaction flow management, the multimodal conversational AI system can deliver seamless and engaging conversations while leveraging AI capabilities for media generation and context tracking. In sum, the multimodal conversational AI system enables flexible, natural, and contextually rich interactions, making it useful for a wide range of applications including but not limited to sales and revenue generation, customer service, education, travel planning, and information retrieval.

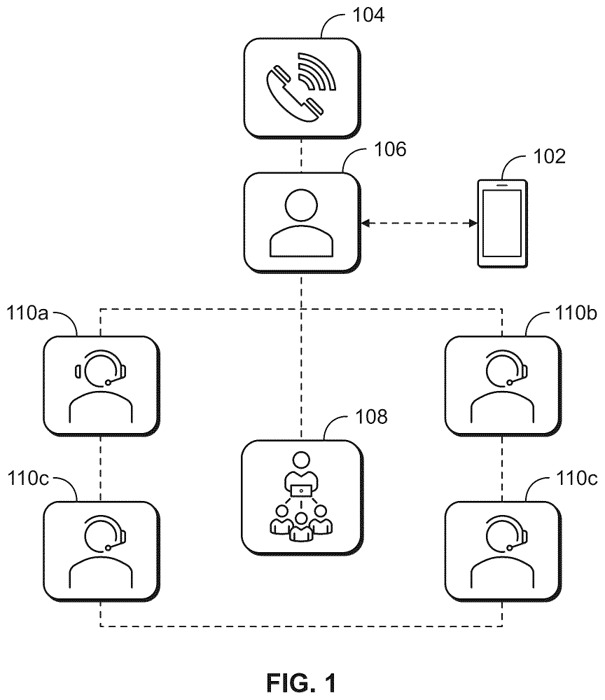

Referring to FIG. 1, illustrated is an exemplary multimodal conversational AI system 100 for facilitating human-like conversations with users via multiple modalities. In the non-limiting exemplary embodiment illustrated in FIG. 1, the system may include a user interface 102 to collect user input and provide generated output to a user. The user interface 102 may include an audio interface and a visual interface. That is, the user interface 102 may receive user input via multiple modalities, including but not limited to audio and visual input. As non-limiting examples, audio input may include phone calls via public switched telephone network (PSTN) or voice over internet protocol (VOIP), audio recordings, audio commands, and the like. As non-limiting examples, visual input may include photographs and videos, scanned documents, text messages, user interaction with the visual output, such as typing or selecting, QR codes, and the like. In an embodiment, the user may be required to opt in to provide visual input. As a non-limiting example, the multimodal conversational AI system 100 may send an SMS text to the user via the user interface 102 to allow the user to opt in to providing visual input. The user interface 102 may also deliver generated output to the user via multiple immersive modalities, including but not limited to audio, text, images, video clips, and other visual output. Output generation and delivery will be discussed in greater detail below.

The multimodal conversational AI system 100 may simultaneously interact with multiple users at a given time. To facilitate efficient handling of multiple inbound calls from users, the multimodal conversational AI system 100 may also include a call management platform 104. The call management platform 104 may be, for example, a software solution tailored to optimize telecommunication workflows within organizations. The call management platform 104 may have sophisticated call routing mechanisms. Additionally, the call management platform 104 may have a call queuing functionality to ensure smooth operations during peak periods by holding calls in the queue and systemically distributing them to available agents to facilitate a “human in the loop”, which are discussed in greater detail below.

The multimodal conversational AI system 100 may also include a control center circuit 106 to control communication between the user interface 102 and the agent circuit 110 described below. The control center circuit 106 can synchronize the audio and visual interfaces of the user device 102. The control center circuit 106 may track the synchronization of the audio interface and visual interface throughout the conversation. The control center circuit 106 may have intelligent tracking identifiers, such as call connection, page number, section number, current question, or previous question, or other associated session attribute, to facilitate the coordination between audio and visual representations of the conversation, ensuring user context is captured and utilized for query processing and prompt generation. In some embodiments, the control center circuit 106 may manage interactions between the visual and audio interfaces. For example, the control center circuit 106 may jump to previous points in the visual output based on an audio input from the user via the user interface 102. In another example, as the system and the user communicate by way of the audio interface, the control center circuit 106 may update the visual interface to display the audio conversation. In another embodiment, the control center circuit 106 may generate ad hoc dialogue from previous dialogue flow or captured events on the visual interface.

The multimodal conversational AI system 100 may also include one or more session managers (or agent(s)) 108 for establishing and maintaining user sessions. The session manager 108 may maintain the state and context of conversations across interactions to provide coherent and contextually relevant responses over the course of a conversation session. When a user begins interacting with the multimodal conversational AI system 100, the session manager 108 may initiate a new user session. In an embodiment, the session manager 108 may assign the user session a unique identifier or link the user session to existing user data if the user has interacted with the multimodal conversational AI system 100 before. When initiating a new user session, the session manager 108 may require authentication, including but not limited to token-based authentication, to maintain secure conversations.

During the multimodal conversation, the session manager 108 may manage workflow and domain accuracy. As a non-limiting example, the session manager 108 may break user input into several small tasks and assign the tasks to task agents specialized to handle that task. Task agents are discussed in greater detail below. In an embodiment, user input may be classified and delegated via vector embeddings. The session manager 108 may also implement fact-checking to ensure that responses generated by the task agents are accurate. In an embodiment, the session manager 108 may implement fact-checking using retrieval-augmented generation (RAG).

The session manager 108 may also track the context of the conversation. For example, the session manager 108 may track and store session metadata including but not limited to caller information and the type of device being used as the user interface 102. Session metadata may be encrypted to maintain data security. The session manager 108 may also track and store variables or data points that are relevant to the user session, such as user preferences or the status of a task being executed by the multimodal conversational AI system 100. The session manager 108 may also track and store information such as call connection, page number, section number, current question, and previous question, session attribute, among other things. The session manager 108 may also store conversation data including user input and task agent responses. This data may be encrypted to maintain data security. Tracking the context of the conversation may also include retrieving data collected during the user session, which may influence how the multimodal conversational AI system 100 interprets and responds to new input. For instance, if a user asks a follow-up question, the session manager 108 may provide context for these questions considering previous exchanges during the user session. The session manager 108 may also ensure that each step of the user session is coherent, accurate, and logically follows from the last, maintaining a smooth and logical flow of conversation. The session manager 108 can also manage and recover from errors, guiding the conversation back on track or resetting the context if needed. The session manager 108 may also maintain security of the user session by limiting the rate of the conversation and detecting anomalies.

The session manager 108 may also manage the user session lifecycle, which includes timing out inactive sessions and properly closing sessions once an interaction has ended, thereby optimizing resource usage and maintaining user privacy. The session manager 108 may facilitate secure session teardown and object cleanup.

The multimodal conversational AI system 100 may also include an agent circuit 110 to interact with the human user. The agent circuit 110 may collect user input and generate appropriate responses using one or more large language models (LLMs). The agent circuit 110 may understand human language in its various forms and nuances, which may include parsing and interpreting user input to determine the intent and relevant information contained within. Based on the interpreted input, agent circuit 110 may formulate responses that are coherent, contextually appropriate, and informative, aiming to mimic human-like interactions. The agent circuit 110 may learn from interactions and improve over time, enhancing the ability to respond more accurately and effectively. The agent circuit 110 may perform specific tasks based on user requests, such as setting reminders, answering questions, providing recommendations, or facilitating transactions.

In some embodiments, the agent circuit 110 may include a prompt driver agent 110a to guide the conversation by generating prompts that encourage user interaction or lead the conversation in a specific direction. The prompt driver agent 110a may set parameters for the LLMs. The prompt driver agent 110a may start a conversation with the user by providing predefined initial greetings or questions that open the dialogue and set the tone for the interaction. The prompt driver agent 110a may interact with the control center circuit 106 and set the flow of questions and answers. The prompt driver agent 110a may adapt to the flow of conversation. To keep the user engaged, the prompt driver agent 110a may generate questions or statements that encourage further interaction. For example, using the prompt driver agent 110a may ask targeted questions that guide users to provide the necessary details and/or steer the conversation towards predefined objectives, such as helping a user complete a transaction, making a reservation, or providing support. The prompt driver agent 110a may also reintroduce questions or provide prompts to revive the interaction and prevent the conversation from stalling if a user does not respond promptly or if the conversation lags. The prompt driver agent 110a may also intervene to clarify misunderstandings or redirect the conversation.

In some embodiments, the agent circuit 110 may include a response agent 110b to respond to prompts generated by the prompt driver agent 110a as well as user input. The response agent 110b may interact with the LLM to formulate responses. The response agent 110b may adhere to predefined rules to structure its responses effectively. As a non-limiting example, the response agent 110b may limit responses to a predefined word limit. Additionally, the response agent 110b may generate responses to maintain focus on relevant topics, ensuring the conversation stays on track. The response agent 110b may collaborate with the prompt driver agent 110a to facilitate a professional and efficient exchange of information. The prompt driver agent circuit 110a may set the direction, while the response agent 110b may support well-crafted responses specifically tailored to each different modality, contributing to the overall effectiveness of the conversation.

In an embodiment, the agent circuit 110 may additionally include specialized task agents 110c configured to perform specialized tasks. As a non-limiting example, an agent circuit 110 may include a specialized task agent 110c to provide information about various dugs and a specialized task agent 110c to provide clinical insights. Specialized task agents 110c may be specialized to any subject area or task.

For the purposes of illustrating the functionality of the multimodal conversational AI system 100, the following non-limiting example is provided. A user may call the multimodal conversational AI system 100 seeking medical information. The control center 106 may establish a user session, capturing the user's caller ID and verifying the user's phone number to ensure a secure conversation. The prompt driver agent 110a may begin the conversation by asking about the user's medical history and current symptoms. As the prompt driver agent 110a interacts with the control center circuit 106 to synchronize audio and visual elements, the user interface 102 may display relevant prompts and questions. At the same time, the response agent 110b may monitor the conversation flow and user inputs to generate responses and update conversation context.

During the conversation, the user may decide to momentarily switch modalities leaving the call to update their last name through the user interface 102. The multimodal conversational AI system 100 may detect this action as a visual event, indicating a change in the user's profile information. The response agent 110b, alerted to the last name change event, may update the corresponding information within the control center circuit 106 to reflect the user's updated profile information. This ensures that the conversation remains personalized and coherent, even after the user returns to the call.

The user may return to the conversation after updating their last name. The prompt driver agent 110a may seamlessly continue the dialogue, with the response agent 110b ensuring that the conversation flow remains consistent and relevant based on the updated user profile information. By integrating the user's last name change into the conversation, the multimodal conversational AI system 100 provides a seamless and personalized user experience, enhancing the effectiveness of the health consultation.

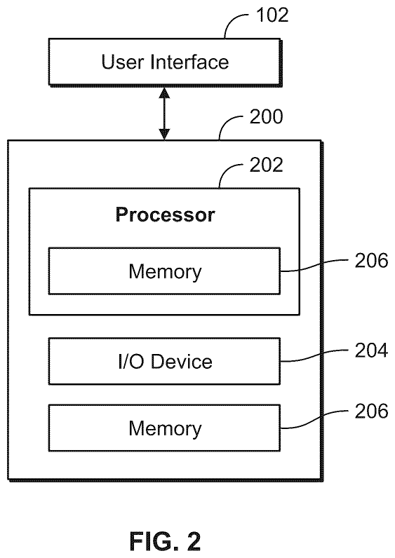

Referring to FIG. 2, illustrated is a schematic representation of a multimodal conversational AI system 100 in accordance with the disclose principles. In the non-limiting exemplary embodiment illustrated in FIG. 2, the multimodal conversational AI system 100 may include a computing device 200 that operates to facilitate a multimodal conversation with a user. The computing device 200 may be a stand-alone device (such as a smart phone or smart glasses), an embedded system, or a plurality of devices configured to perform the functions described herein. Furthermore, the computing device 200 may communicate with one or more user interfaces 102.

In the non-limiting exemplary embodiment illustrated in FIG. 2, the computing device 200 may include a processor 202. The processor 202 may be a programmable type, a dedicated, hardwired state machine, or a combination thereof. The processing device 202 may further include multiple processors, Arithmetic-Logic Units (ALUs), Central Processing Units (CPUs), Graphics Processing Units (GPUs), Digital Signal Processors (DSPs), and Field-programmable Gate Arrays (FPGA), among other things. For forms of the processor 202 with multiple processing units, distributed, pipelined, or parallel processing may be used. The processor 202 may be dedicated to performance of just the operations described herein or may be used in one or more additional applications. The processor 202 may be of a programmable variety that executes processes and processes data in accordance with programming instructions (such as software or firmware) stored in a memory 206, which is discussed in greater detail below. Alternatively or additionally, programming instructions may at least partially defined by hardwired logic or other hardware. The processor 206 may be comprised of one or more components of any type suitable to process the signals received from the input/output device 204 or elsewhere, and provide desired output signals. Such components may include digital circuitry, analog circuitry, or a combination thereof.

The computing device 200 may also include an input/output device 204 to enable communication with one or more user interfaces 102 and/or external data sources. For example, the input/output device 204 may be a network adapter, a network credential, an interface, or a port (e.g., a USB port, serial port, parallel port, an analog port, a digital port, VGA, DVI, HDMI, FireWire, CAT 5, Ethernet, fiber, Bluetooth, or any other type of port or interface), among other things. The input/output device 304 may be comprised of one or more of hardware, software, and firmware. The input/output device 304 may have one or more of adapters, credentials, interfaces, or ports, such as a first port for receiving data and a second port for transmitting data, among other things. As previously described, the user interface 102 may be any type of device that allows data to be input to or output from the computing device 200. For example, the user interface 102 may be a meter, a control system, a sensor, a mobile device, a reader device, equipment, a handheld computer, a diagnostic tool, a controller, a computer, a server, a printer, a display, a visual indicator, a keyboard, a mouse, or a touch screen display, among other things. Input interfaces may include, for example, microphones, cameras, touchscreens, keyboards, scanners, and network interfaces. Output interfaces may include, for example, speakers, displays, and network interfaces. In an embodiment, the user interface 102 may be integrated into the computing device 200. More than one external device may be in communication with the computing device 200.

The computing device 200 may also include a memory 206. The memory 206 in different embodiments may be of one or more types, such as a solid-state variety, electromagnetic variety, optical variety, or a combination of these forms, to name but a few examples. Furthermore, the memory 206 may be volatile, nonvolatile, transitory, non-transitory or a combination of these types, and some or all of the memory 206 may be of a portable variety, such as a disk, tape, memory stick, or cartridge, among others. In addition, the memory 206 may store data which is manipulated by the processor 202, such as data representative of signals received from or sent to the input/output device 204 in addition to or in lieu of storing programming instructions, among other things. The memory 206 may be included with the processor 202. Alternatively, the memory 206 may be a separate component coupled to the processor 202. The memory 206 may include a context database for storing and retrieving conversation context, user profiles including user preferences and information collected from previous conversations, topic definitions, and predefined dialog flows, as well as user input and generated output from the current conversation

In an embodiment, the computing device 200 may receive user audio and/or visual input via the input/output device 204. The processor 202 may map and analyze the user input for intent. To map user intent, the processor 202 may extract and curate vocabulary and phrases from user input. The processor 202 may then retrieve domain-specific terminology from the memory 206 and/or an external data source. The processor 202 may also retrieve information corresponding to conversation context from the memory 206 to further analyze user input. The processor 202 may generate a multimodal response containing audio and/or visual output based on the analysis of user input. The computing device 200 may deliver the multimodal response to the user interface 102 via the input/output device 204. Responses generated by the processor 202 may be stored in the memory 206 to enhance future performance. The processor 202 may also generate a structured call summary for delivery to the user. The call summary may be temporarily stored in the memory 206 and may be automatically deleted after a specified period of time.

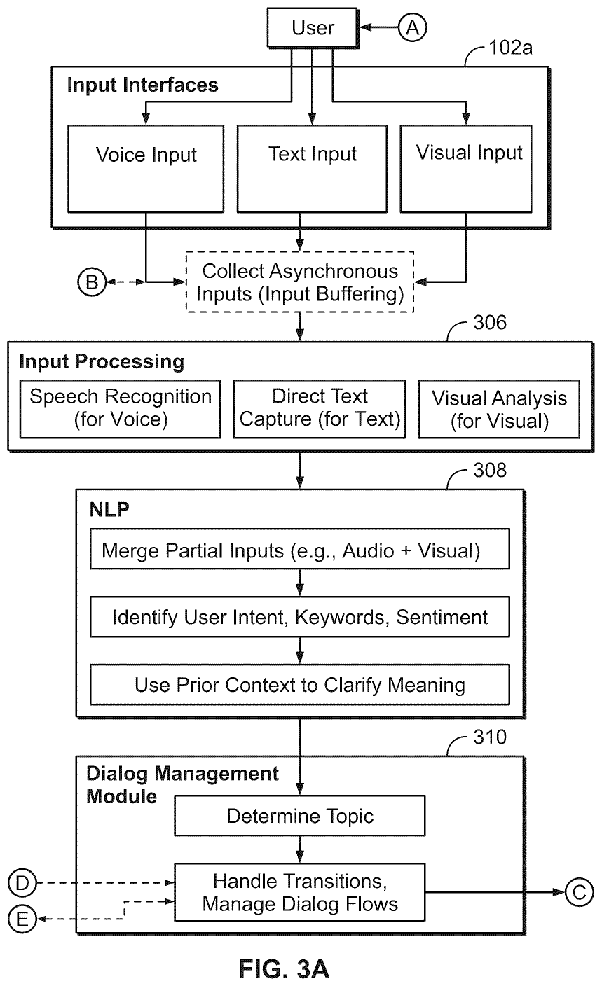

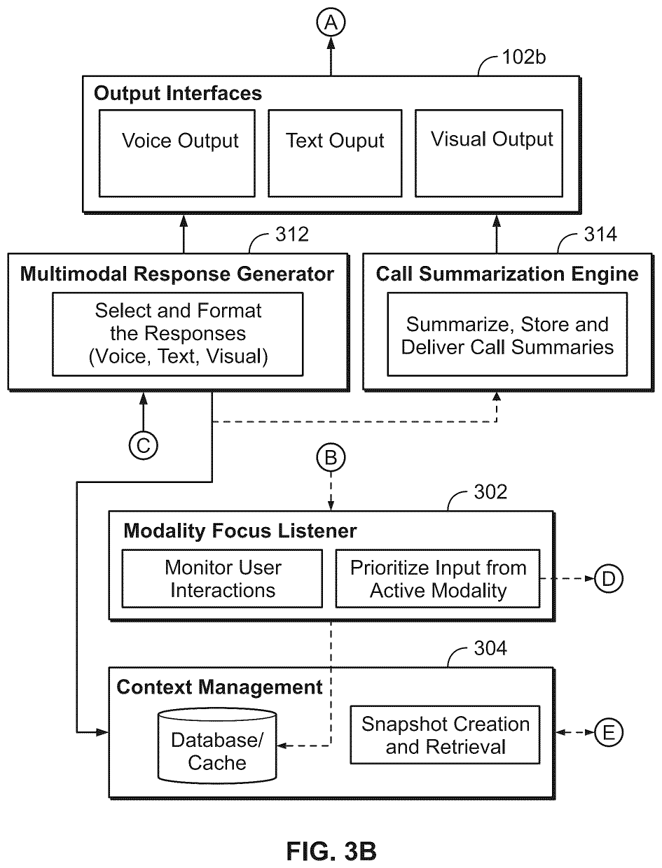

Referring to FIGS. 3A-3B, illustrated are a schematic representation of a multimodal conversational AI system 100 in accordance with the disclosed principles. Looking at FIGS. 3A-3B collectively, as previously described, the multimodal conversational AI system 100 may include a user interface 102 to collect user input and provide output to the user. The user interface 102 may include one or more input interfaces 102a for collecting user input, including but not limited to audio and visual input such as voice, text, images, and video. The input interfaces 102a may include, for example, microphones, keyboards, touchscreens, cameras, and scanners. The user interface 102 may also include one or more output interfaces 102b for providing output to the user generated by the multimodal conversational AI system 100, including but not limited to audio and visual output. The output interfaces 102b may include, for example, speakers and display screens.

The multimodal conversational AI system 100 may include a modality focus listener 302 to handle concurrent asynchronous user input collected via the user interface. The modality focus listener 302 may actively monitor for audio and visual input from the user. The modality focus listener 302 may also determine the active modality based on user activity. That is, the modality focus listener 302 may determine whether user input audio input or visual input. For example, the modality focus listener 302 may determine whether the user is providing input via speaking, typing, gesturing, or clicking on the user interface 102. The multimodal conversational AI system 100 may then tailor output to the active modality identified by the multimodal focus listener 302. As a non-limiting example, if the modality focus listener 302 determines that the user is providing predominantly audio input, the responses generated and delivered by the multimodal conversational AI system 100 may prioritize audio output. The modality focus listener 302 may also facilitate dynamic modality switching such that the multimodal conversational AI system 100 can seamlessly switch between audio and visual output based on user input and conversation context. For example, a complex question might initially be answered with a visual summary, followed by an audio explanation if the user requests further detail (or conversely an audio summary with a visual text detail the user can scroll while listening to the summary being spoken). The modality focus listener 302 may use a multimodal switching logic to toggle focus between audio and visual input and predict modality shifts based on conversation patterns. The modality focus listener 302 may also trigger the context management module to update the context of the conversation, discussed in greater detail below.

The multimodal conversational AI system 100 may include a context management module 304 to manage a unified conversation context. The context management module 304 may create snapshots of the context at specific points in the conversation. That is, the context management module 304 may create a snapshot following the receipt of each user input and delivery of each multimodal response such that the context of the conversation is constantly updated. The context management module 304 may also include a database or cache to store snapshots for subsequent retrieval, discussed in greater detail below. Snapshots may also include conversation information including but not limited to user information, conversation history, current topic, dialog state, information extracted from inputs (e.g., dates, locations, entities), and active modality.

The context management module 304 may allow for contextual awareness across multiple modalities. That is, when the user switches modalities (e.g., from visual to audio), the stored snapshot may be referenced and made available to the new modality, thereby providing context continuity. As a non-limiting example, the user may focus on a specific paragraph of the visual output displayed on the user interface. The user may then make a request via audio input, such as the phrase “tell me more about this.” The multimodal conversational AI system 100 may retrieve the snapshot including the visual context of the conversation to interpret the user's audio input and generate a context-appropriate response.

The context management module 304 may also allow for contextual awareness of the conversation across various topics. That is, the context management module 304 may also allow the conversation to branch into different topics and subsequently return to specific points in the conversation. As a non-limiting example, a user may provide input to inquire about flight availability. Upon receiving this input, the context management module 304 may create a snapshot indicating, among other things, that the topic of the conversation is “Booking Flights”. The user may then inquire about the weather in Paris. Upon receiving this input, the context management module 304 may create a snapshot indicating that the topic of the conversation has transitioned to “Local Attractions”. The user may then inquire about baggage allowance. Upon receiving this input, the context management module 304 may create a snapshot indicating that the topic of conversation is once again “Booking Flights.” The multimodal conversational AI system 100 may retrieve the first snapshot such that the conversation within the topic of “Booking Flights” picks up where it left off. As another non-limiting example, within a conversation regarding luxury hotels, a user may explore a tangent about budget travel. This tangent may include a variety of topics including, for example, “Budget Flights”, “Affordable Hotels”, and “Discount Passes”. The user may then request to return to the conversation about luxury hotels. Upon receiving this request, the multimodal conversational AI system 100 may retrieve the snapshot corresponding to the point in the conversation prior to the tangent. Accordingly, the context management module 304 may allow the user to branch into various topics without losing previous conversation context and progress.

The multimodal conversational AI system 100 may include a multimodal input processing module 306 to process audio and visual input from the user. The multimodal input processing module 306 may include a voice activity detector with a set minimum and maximum speech duration to improve speech detection accuracy while filtering noise and silence. The multimodal input processing module 306 may reduce background noise by filtering out non-speech frames using a denoising algorithm. In an embodiment, the multimodal input processing module 306 may automatically detect the language(s) present in the audio input. The detect language may be captured as part of a snapshot and stored in the context management module 304. Additionally or alternatively, using the user interface 102, the user may manually select a language for the conversation. The multimodal input processing module 306 may include a speech recognition engine for processing audio input from the user. The speech recognition engine may convert audio to text. The multimodal input processing module 306 may also include a direct text capture engine for processing text input provided by the user. The multimodal input processing module 306 may also include a visual analysis engine for processing visual input such as video and images. As previously discussed, audio and visual input may be simultaneously received and processed to enhance contextual awareness.

The multimodal conversational AI system 100 may also include a Natural Language Processing (NLP) engine 308 integrate data corresponding to audio and visual input from the user. The NLP engine 308 may merge audio and visual data to improve conversation context. The NLP engine 308 may also segment user input data, extract keywords, and identify topics within the user input, as well as perform sentiment analysis and determine user intent. The NLP engine 308 may also retrieve and utilize snapshots stored in the context management module 304 to gain context and clarify the meaning of user input. The NLP engine 308 may merge user input fractured across multiple modalities to determine user intent. As a non-limiting example, a user may simultaneously or successively provide visual input by typing “flights” and audio input by saying “to London”. The NLP engine 308 may combine the visual and audio inputs to determine that the user is requesting information about “flights to London.” The multimodal conversational AI system 100 may use this information to generate a comprehensive response to the user inquiry. As another non-limiting example, a user may simultaneously or successively provide audio input by asking a question about a document and visual input by scanning the document. The NLP engine 308 may process both the audio and visual inputs to determine that the user is requesting information about the scanned document. The multimodal conversational AI system 100 may use this information to generate a comprehensive response to the user inquiry.

The multimodal conversational AI system 100 may also include a dialog management module 310 to identify conversation topics and manage dialog flows and transitions. The dialog management module 310 may identify one or more topics present in the conversation based on a list of predefined topics. Topics may be defined based on keywords, semantic analysis, named entity recognition, and/or machine learning models. Examples of topics include but are not limited to “Travel,” “Technology,” “Finance”, and “Healthcare” among others. Vocabulary and phrases for specific topics may be extracted and curated by, for example, fetching topic-specific data from online articles and industry reports and/or previous user input stored in the memory. This data may be embedded, stored, and integrated with the multimodal conversations AI system 100 for the purposes of identifying and understanding business domain specific vocabulary. Topic boundaries may be dynamically redefined based on user input and conversation context. The dialog management module 310 may manage dialog flow by implementing predefined dialog flows within a topic. The dialog management module 310 may use state machines to implement predefined dialog flows. As a non-limiting example, predefined dialog flows may ensure that dialogs within a topic are hierarchical. The dialog management module 310 may also facilitate topic and dialog transitions based on user input, conversation context, and pre-defined rules. As a non-limiting example, the dialog management module 310 may transition from a predefined “Local Attractions” dialog within a “Travel” topic to a predefined “Hotel Reservations” dialog within a “Travel” topic when the user input includes the phrase “what are the best hotels in Paris?”. The dialog management module 310 may also trigger the context management module 304 to create a snapshot such that the context of the conversation is updated.

The multimodal conversational AI system 100 may also include a multimodal response generator 312 to generate immersive audio and visual output for delivery to a user. The multimodal response generator 312 may select the best output modality based on context, including but not limited to active modality, user preferences, and content type. The multimodal response generator 312 may tailor output to the selected modality and user preference. In an embodiment, audio output may be concise and may include spoken language while visual output may include more detailed formatted text, images, and charts. As a non-limiting example, if the user requests a quick confirmation of information, the modality response generator 312 may generate a brief audio output. On the other hand, if the user requests a detailed itinerary, the multimodal response generator 312 may generate a comprehensive visual output. In yet another example, if the user requests a map of attractions, the multimodal response generator 312 may generate an interactive visual output. The multimodal response generator 312 may also combine information from different modalities to generate integrated multimodal output. As a non-limiting example, a user may provide audio input to inquire about a specific landmark. In response, the multimodal response generator 312 may provide an audio output including a spoken description as well as a visual output including an image of the landmark.

The multimodal conversational AI system 100 may also include a summarization engine 314 to generate, store, and deliver call summaries to users. The summarization engine 314 may include or access an NLP engine to generate the call summaries. Call summaries may include several components, including but not limited to transcripts and AI-enhanced PDF reports. Call summaries may be segmented according to topic. The call summaries may be temporarily stored in the memory as previously described. Call summaries stored in an external memory such as a cloud-based memory may be encrypted prior to storage. The summarization engine 314 may also deliver the call summaries to users. As a non-limiting example, the summarization engine 314 may deliver a call summary to a user by sending a secure, time-limited download link to the user interface 102 identified by the session manager when the user session was established.

The immersive multimodal conversational AI system 100 may be configured to simultaneously serve multiple tenants while ensuring customer isolation, scalability, security, and separate billing and reporting. In an embodiment, the multimodal conversational AI system 100 may provide a separate AI service for each tenant. AI services for each tenant may be logically and/or physically separated. The multimodal conversational AI system 100 may also include a secure tenant management platform to handle tenant onboarding, authentication, and permissions for the tenant's AI service. The multimodal conversational AI system 100 may include an application programming interface (API) gateway to route user calls to the appropriate tenant's AI service. The multimodal conversational AI system 100 may also include separate tenant-specific data storage for each tenant including tenant metadata and chat logs to maintain data security and machine learning configuration. Tenant-specific data storage may also include usage and billing logs for resource and cost tracking.

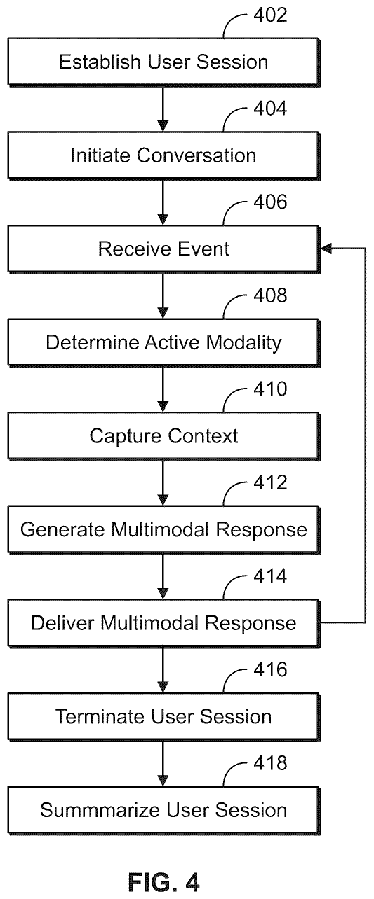

Referring to FIG. 4, illustrated is a flowchart 400 of an exemplary process for operating a multimodal conversational AI system 100 in accordance with the disclosed principles. The process illustrated in flowchart 400 may be implemented in whole or in part in one or more of the multimodal conversational AI system 100 disclosed herein. In some embodiments, the steps of flowchart 400 may be performed by separate devices. In additional or alternative embodiments, all steps of flowchart 400 may be performed by the same device. It shall be further appreciated that a number of variations and modifications to the process illustrated in flowchart 400 are contemplated including, for example, the omission of one or more aspects of the process, the addition of further conditionals and operations, or the reorganization or separation of operations and conditionals into separate processes.

Flowchart 400 begins with Step 402, wherein a user session is established. A user session may refer to a period of interaction between a user and the system that is kept track of by a server or application. The user session may begin when a user accesses the multimodal conversational AI system by, for example, opening a voice channel such as making a phone call to the system or other text driven interface. As previously discussed, the call management platform may facilitate efficient handling of inbound phone calls or requests. A new user session may be initiated by the session manager. In some embodiments, establishing the user session may include determining at least one of a caller ID, a phone number, session ID, or a verification status. The verification status may include determining a user identity. In some embodiments, establishing a user session may include detecting the type of user interface 102.

In Step 404, a conversation with a user may be initiated via the user interface. The conversation may be initiated using visual and/or audio output. The conversation may begin using audio output before using visual output, or vice versa. As previously described, in some embodiments, the prompt driver agent may initiate the conversation by prompting the user for information.

In Step 406, audio and/or visual events are received. The modality focus listener, as previously described, may actively monitor for audio and visual events. Audio events may include audio input including various components of user speech, including but not limited to starts, stops, pauses, specific audio commands, and content. The audio event may include a user auditory response to a question provided by a prompt driver agent of the multimodal conversational AI system. In some embodiments, an audio event may also include a question asked or prompt given by an agent circuit as previously described. A visual event may include visual input including but not limited to user selection or action on the visual interface. For example, a visual event may include clicking on a specific element, highlighting text, scrolling to a new section, typing in a text box, and using a visual gesture such as drawing a circle around an area. A visual event may also include scanning a QR code using the user interface or uploading a photo. In some embodiments, the visual event may include a user textual response to a question provided by a prompt driver agent of the multimodal conversational AI system. Audio and visual events may be received simultaneously. As a non-limiting example, the multimodal conversational AI system may simultaneously receive audio and visual input when a user might points to a specific element of the visual output displayed on the user interface and asks a question about the element via audio input.

As previously described, multiple concurrent audio and visual events may be simultaneously received. The multimodal conversational AI system may process concurrent input via the modality focus listener and context management module as previously described. In Step 408, the active modality is determined. After an audio or visual event is detected in Step 406, the modality focus listener may determine whether the event is an audio or visual event, thus identifying the active modality. As previously discussed, the modality focus listener may actively monitor for audio and visual events. The modality focus listener may also actively monitor for user requests to switch to a different modality. Thus, the modality focus listener may update the active modality throughout the conversation. As previously discussed, the multimodal conversational AI system may tailor responses to the active modality.

In Step 410, a snapshot of the conversation is captured and stored. The snapshot may be created and stored by the context management module as previously described. The snapshot may include the context of the conversation at a given point, including but not limited to the active modality (e.g., if the user just clicked on a chart, the context now includes “user is focused on this specific chart”), the specific event (e.g., if the user said “explain this,” the context now includes “user wants explanation”), and user input associated with the event (e.g., if the user typed “interest rates” in a search box, the context includes “user is interested in interest rates”). The multimodal conversational AI system may capture and store a conversation snapshot following each input received and output delivered to maintain an updated context of the conversation at a given point in time. The updated context may be used in subsequent steps described below to facilitate a unified conversation based on each processed input, including information derived from multiple modalities and across different topics and dialogs.

In Step 412, audio and visual events are processed. The audio and visual events may be processed and integrated by the previously described input processing engine and NLP engine. Event processing may include captured context and customer intent and/or multi-intent to identify keywords and determine customer intent and sentiment. Event processing may also include retrieving snapshots from the context management module to process events in the context of the conversation. As previously described, the system can process multiple concurrent inputs.

In Step 414, a multimodal response is generated. The immersive multimodal response may include one or more of dynamically generated audio (e.g., PSTN, VOIP, TTS, and audio messages) output and visual (e.g., images, videos, charts, diagrams, QR codes, interactive elements, and text including text SMS, MMS, chat, email, documents) output. In an embodiment, the responses may be limited to a predetermined word count, depending on the modality. As a non-limiting example, audio responses may be limited to 20 spoken words while visual responses may be liked to 60 written words. The response may be tailored to a particular modality based on active modality, current conversation context, user request, and user preference. As a non-limiting example, the multimodal response may include more audio output than visual output when user input is primarily audio. The multimodal conversational AI system may access stored conversation snapshots to generate a response considering user intent, keywords, topic, sentiment, and conversation context.

In Step 416, visual and audio output corresponding to the multimodal response generated in Step 414 may be delivered to the user. As previously discussed, immersive audio and visual output may be delivered to the user via the user interface. Delivery of multimodal output may also include synchronizing audio and visual output. Synchronizing the output may include tracking at least one of a session ID, call connection, a page number, a section number, a current question, or a previous question. As a non-limiting example, audio output may be synchronized with a visual event received in Step 406, such as the user editing portions of the visual output using the user interface 102. For example, the user may correct the spelling of their name by modifying the visual output of the name on the user interface. The audio output may then provide a modified pronunciation of the user's name in accordance with the user's correction. As another non-limiting example, an audio event received in Step 406 may be synchronized with the visual output by modifying a visual output of the conversation after receiving the audio conversation modification. For example, the user may, while speaking to the conversational AI agent, ask about drug side effects. In response, the visual interface may display a list of side effects for a drug. In another example, the user may, while speaking to the conversational AI agent, ask to review a previous point in the conversation. In response, the visual interface may display the previous point in the conversation. In still another example, the visual interface may display a visual representation of the audio conversation, which may be verbatim or a conversation summary.

After the multimodal response is delivered to the user via the user interface, the process may return to Step 406 and additional audio and/or visual events may be received. The process illustrated in flowchart 400 may repeat to continue the multimodal conversation. Throughout the conversation, the multimodal conversational AI system may continue to capture and store snapshots to update the context of the conversation. For example, the modality focus listener may determine a new active modality, thereby updating the context of the conversation. The multimodal conversational AI system may utilize the updated conversation context for generating subsequent immersive multimodal responses. The system may also retrieved stored snapshots to return to account for previous context of the conversation, enabling the conversation to evolve from the current point or return to a previous point in the conversation history, including a point associated with a specific snapshot context. By repeating the process illustrated in flowchart 400, the multimodal conversational AI system may facilitate a human-like conversation with a user across multiple modalities.

In Step 418, the user session may be terminated. The multimodal conversational AI system may monitor for user input and terminate the user session when user input is not received for a set period of time. In an embodiment, the multimodal conversational AI system may additionally or alternatively monitor for user input indicative of the user's intention to terminate the conversation. As a non-limiting example, the multimodal conversational AI system may monitor for audio input including the phrase “goodbye” or visual input including the user's selection of an “end call” button. As previously mentioned, the modality focus listener may actively monitor for audio and visual input from the user. The session manager may time out inactive sessions and close the user session once an interaction has ended, thereby optimizing resource usage and maintaining user privacy.

In Step 420, a summary of the user session may be generated, stored, and delivered to the user. Call summaries may be generated using an NLP engine. The call summaries may be temporarily stored in the memory as previously described. Call summaries stored in an external memory such as a cloud-based memory may be encrypted prior to storage. Call summaries may also be delivered to users in Step 420. As a non-limiting example, the call summary may be delivered to a user by sending a secure, time-limited download link to the user interface used during the session. As previously mentioned, in some embodiments, call summaries may be generated, stored, and delivered by the call summarization engine.

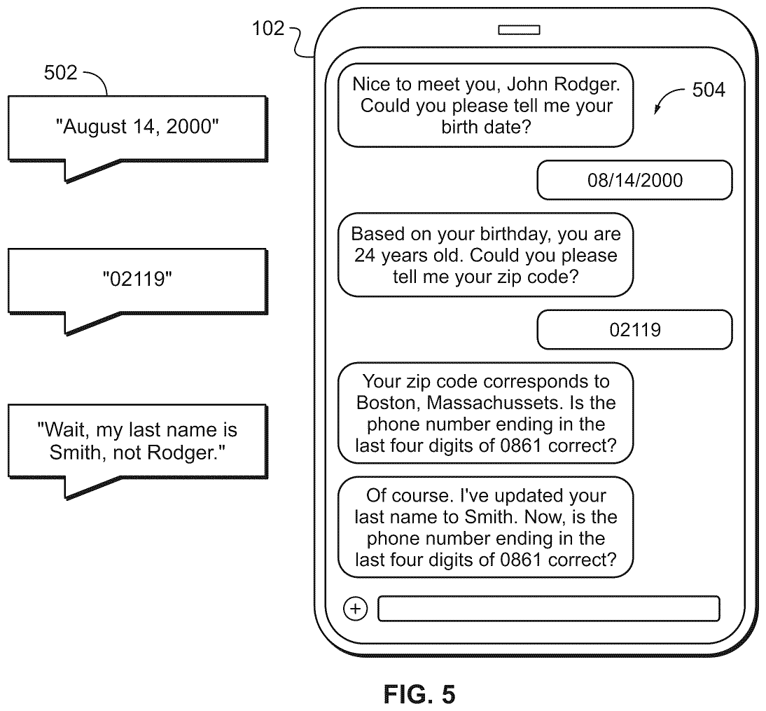

Referring to FIG. 5, illustrated is an exemplary multimodal conversation between a user and the multimodal conversational AI system 100 in accordance with the disclosed principles. In the non-limiting embodiment illustrated in FIG. 5, the multimodal conversational AI system 100 may integrate audio and visual context to generate comprehensive responses to user input, thereby facilitating a multimodal conversation with the user. In the non-limiting exemplary embodiment illustrated in FIG. 5, the user may provide audio input 502 via the user interface 102 as illustrated on the left side of FIG. 5. The user interface 102, illustrated on the right side of FIG. 5, may display synchronized visual output 504 generated by the multimodal conversational AI system 100. The visual output 504 displayed on the user interface 102 may be synchronized with the audio input 502 by showing a visual representation of the audio portion of the conversation. In some embodiments, the user interface 102 may display a portion of the voice conversation, including but not limited to prompts presented to the user, user responses to specific prompts, and user responses used to complete a form, among other things. In the non-limiting exemplary embodiment illustrated in FIG. 5, user information, i.e., date of birth and zip code, provided by the user via audio input 502 is shown as visual output 504 on the user interface 102.

The multimodal conversational AI system 100 may also detect and respond to user input that is not responsive to prompts presented to the user. In the non-limiting exemplary embodiment illustrated in FIG. 5, the multimodal conversational AI system 100 may prompt the user to confirm the last four digits of the phone number. Instead of responding to the prompt, the user, noticing the last name displayed in an earlier prompt was incorrect, may provide audio input 502 including user's correct last name. For example, the user may edit the last name from “Rodger” to “Smith” by providing audio input via the user interface 102. In some embodiments, the user may additionally or alternatively correct errors by editing portions of the visual output 504 by providing visual input via the user interface 102. In response, multimodal conversational AI system 100 may update the user's name data accordingly and provide visual output 504 on the user interface 102 indicating that the last name was updated. The multimodal conversational AI system 100 may then revert to the earlier prompt, asking the user to confirm the last four digits of the phone number via visual output 504. The multimodal conversational AI system 100 may reference the updated name data at subsequent points in the conversation.

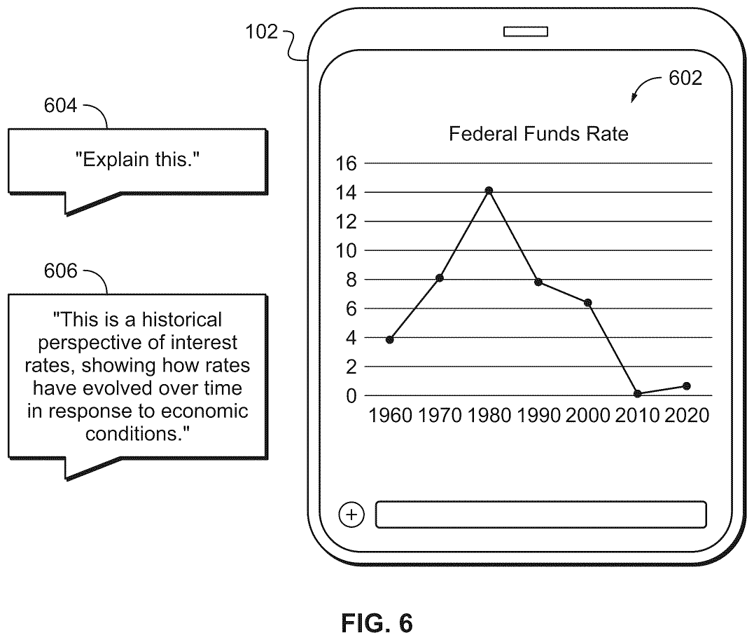

Referring to FIG. 6, illustrated is another exemplary multimodal conversation between a user and the multimodal conversational AI system 100 in accordance with the disclosed principles. In the non-limiting embodiment illustrated in FIG. 6, the multimodal conversational AI system 100 may integrate audio and visual context to generate comprehensive immersive dynamically generated responses to user input, thereby facilitating a multimodal conversation with the user. The user interface 102, illustrated on the right side of FIG. 6, may display a visual output 602 corresponding to the conversation. As a non-limiting example, the user interface 102 may display a chart on interest rates. The modality focus listener may detect that the prioritized modality is visual. The context management module may create and store a snapshot of the visual output to establish visual context for the conversation: “user is viewing a chart on interest rates”. The user may provide audio input 604 corresponding to the visual output 602 displayed on the user interface 102, as illustrated on the left side of FIG. 6. As a non-limiting example, the user input may include the phrase “explain this.” The input processing engine may process the audio input to convert the speech to text. The multimodal focus listener may detect the audio event and identify that the active modality is now audio. The context management module may update the snapshot of the conversation to include both the previously established visual context comprising the visual output 602 (“user is focused on this specific chart on interest rates”) and the audio input 604 (“user wants explanation”). Using this combined context, the NLP engine may identify user intent and clarify meaning. The dialog management module may determine that the topic is “Interest Rates” and implement a pre-defined dialog flow within the topic. The multimodal response generator may generate a response that explains the visual output 602 displayed on the user interface 102. In the non-limiting exemplary embodiment illustrated in FIG. 6, the multimodal response generator may generate audio output 606 explaining interest rate chart displayed on the user interface 102. The audio output may be delivered to the user via the user interface.

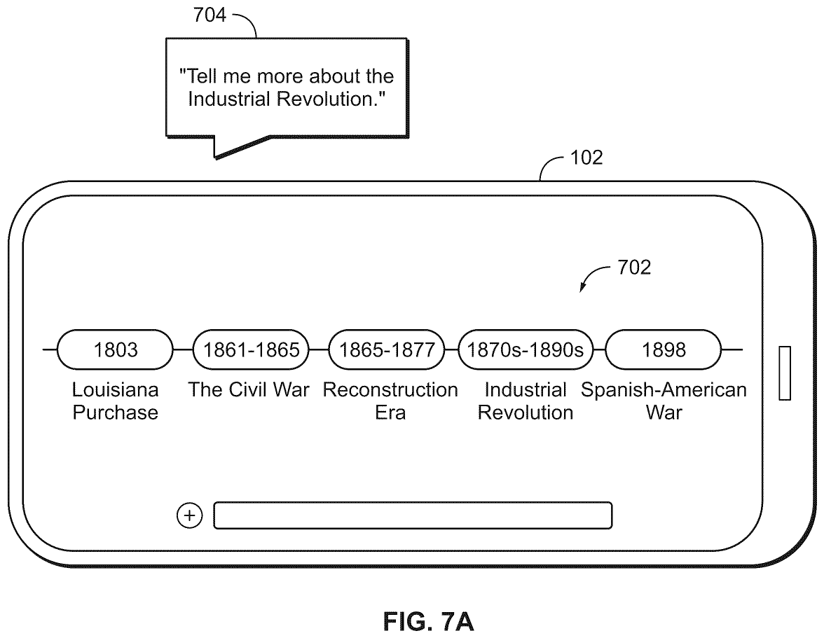

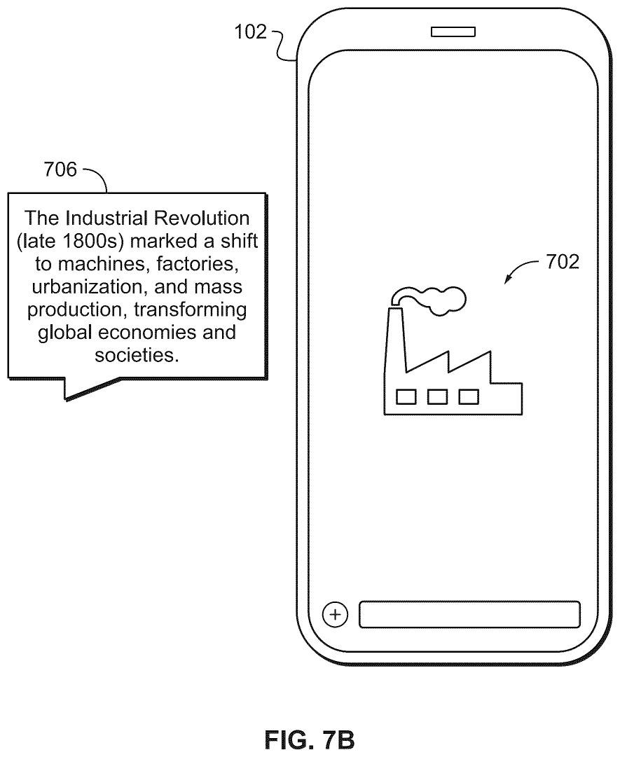

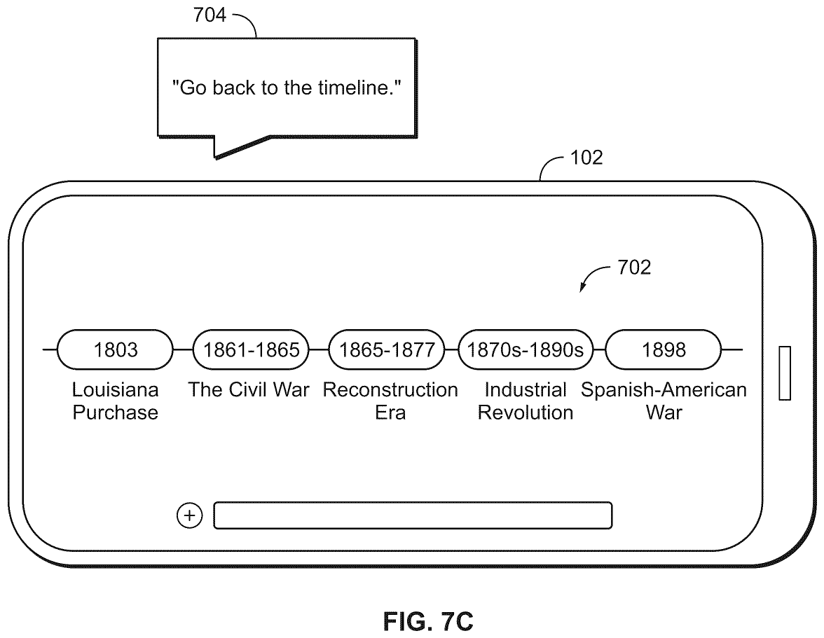

Referring to FIG. 7A, FIG. 7B, and FIG. 7C (collectively, FIG. 7), illustrated is another exemplary multimodal conversation between a user and the multimodal conversational AI system 100 in accordance with the disclosed principles. In the non-limiting embodiment illustrated in FIG. 7, the multimodal conversational AI system 100 may retrieve snapshots of the conversation to seamlessly return to previous points in conversation.

In the non-limiting exemplary embodiment illustrated in FIG. 7A, the user interface 102 may display a timeline of historical events focusing on the 1800s. The modality focus listener may detect that the prioritized modality is visual. The context management module may create and store a snapshot of the visual output 702 to establish visual context for the conversation: “user is viewing a timeline of historical events, focused on the 1800s”. The user may provide audio input 704 corresponding to the visual output 702 displayed on the user interface 102, as illustrated on the left side of FIG. 7A. As a non-limiting example, the user audio input 704 may include the phrase “tell me more about the Industrial Revolution.” The input processing engine may process the audio input by, for example, converting the speech to text. The NLP engine may identify keywords present in the audio input such as “Industrial Revolution” and user intent (“user wants more information about the Industrial Revolution”). The multimodal focus listener may detect the audio event and identify that the active modality has changed to audio. The context management module may update the snapshot of the conversation to include both the previously established visual context (“user is focused on the 1800s portion of the timeline of historical events”) and the audio input 704 (“user wants more information about the Industrial Revolution”). The dialog management module may determine that the topic is “Industrial Revolution” and may implement a pre-defined dialog flow within that topic. Using the updated snapshot context, the multimodal response generator may generate a multimodal response, providing output responsive to the user input.

In the non-limiting exemplary embodiment illustrated in FIG. 7B, the multimodal conversational AI system 100 may generate audio output 706 providing more information about the Industrial Revolution. The multimodal conversational AI system 100 may also generate visual output 702 providing, for example, images depicting the Industrial Revolution. The conversation may then branch into a focused discussion about the Industrial Revolution. At some point during the conversation, the user may wish to return to the visual output 702 previously displayed on the user interface 102. The user may accomplish this by providing audio and/or visual input via the user interface 102.

In the non-limiting exemplary embodiment illustrated in FIG. 7C, the user may provide audio input 704 including the phrase “go back to the timeline.” The input processing engine may process the audio input by, for example, converting the speech to text. The NLP engine may identify user intent (“user wants to return to the timeline”). The multimodal focus listener may detect the audio event and identify that the active modality is visual based on the user's request. The context management module may retrieve the snapshot corresponding to the previous point in the conversation. In the non-limiting example illustrated in FIG. 7C, the visual output 702 displayed on the user interface 102 may once again include a timeline of historical events, specifically focused on where the user left off, in the 1800s. The conversation may then branch into other topics depending on user input. While the visual output 702 provided in this exemplary embodiment is static and used as a reference for the audio modality, in additional or alternative embodiments the audio outputs 706 and visual outputs 704 may evolve dynamically in unison as previously described. As a non-limiting example, the audio output 706 may provide a summary while the visual output 702 is updated with a more detailed explanation or answer to the user's inquiry.

In yet another non-limiting exemplary multimodal conversation, the user may begin the conversation by providing audio input via the user interface including the phrase “I'm planning a trip to Italy.” The modality focus listener may detect that the prioritized modality is audio. The context management module may create and store a snapshot of the audio input to establish context for the conversation: “user is interested in the topic of Travel”. The user may then provide visual input via the user interface by scanning a QR code from a travel brochure. The modality focus listener may detect that the prioritized modality has changed to visual. The context management module may create and store a snapshot of the visual input to update visual context for the conversation: “user is viewing a travel brochure”. The user may then provide audio input including the question “what are some good places to visit?”. The modality focus listener may detect that the prioritized modality is audio. The context management module may create and store a snapshot of the audio to update context for the conversation: “user would like suggestions of locations related to Italy and the brochure”. The multimodal conversational AI system may generate and deliver audio and/or visual output with appropriate suggestions.

In yet another non-limiting exemplary multimodal conversation, the multimodal conversational AI system may serve as technical support for a user. For example, the user may begin the conversation by providing visual input via the user interface by typing a question. The modality focus listener may detect that the prioritized modality is visual. The context management module may create and store a snapshot of the visual input to update visual context for the conversation, including the topic area of the question asked by the user. The user may then upload a screenshot of an error message. The context management module may create and store a snapshot of the visual input to update visual context for the conversation. The multimodal conversational AI system may analyze both visual inputs to generate and deliver an accurate and helpful response.

In another non-limiting exemplary multimodal conversation, the multimodal conversational AI system may be used to assist a user in purchasing a new vehicle. For example, the user may begin the conversation by providing visual input via the user interface by typing purchase requirements such as budget and family needs. The modality focus listener may detect that the prioritized modality is visual. The context management module may create and store a snapshot of the visual input to update the visual context for the conversation, including the topic area of the conversation. The user may then upload images, such as a photo of a similar model with a desired feature from another car such as color. The context management module may create and store a snapshot of the visual input to update the visual context of the conversation. The multimodal conversational AI system may analyze both visual inputs to generate and deliver an informative response such as interior 360-degree views or renderings of the vehicle in specific configurations, allowing for effective exploration, comparison, and immersive 3D visualization within a single, interactive session.

While this disclosure has been particularly shown and described with reference to preferred embodiments, it will be understood by those skilled in the pertinent field of art that various changes in form and detail may be made therein without departing from the spirit and scope of the disclosed principles. The inventors expect skilled artisans to employ such variations as appropriate, and the inventors intend the disclosed principles to be practiced otherwise than as specifically described herein. Accordingly, this disclosure includes all modifications and equivalents of the subject matter recited in the claims appended hereto, as permitted by applicable law. Moreover, any combination of the above-described elements in all possible variations thereof is encompassed by the disclosure unless otherwise indicated herein or otherwise clearly contradicted by context.

Also, while various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the disclosed principles set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” or disclosed principles in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

Moreover, the Abstract is provided to comply with 37 C.F.R. § 1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the following claims are hereby incorporated into the Detailed Description, with each claim standing on its own as a separate embodiment.

Any and all publications, patents, and patent applications cited in this disclosure are herein incorporated by reference as if each were specifically and individually indicated to be incorporated by reference and set forth in its entirety herein.

What is claimed is:

1. An immersive multimodal conversational AI system, comprising:
a plurality of input interfaces configured to receive a corresponding plurality of modalities of user input and a plurality of output interfaces configured to deliver a corresponding plurality of modalities of generated output to the user;
memory storing user input, generated output, and instructions; and
a processor communicatively coupled to the plurality of input interfaces, the plurality of output interfaces, and the memory, wherein the processor is configured to execute the instructions to:
process the plurality of modalities of user input,
generate a dynamic contextually-aware real-time multimodal response comprising the plurality of modalities of generated output.

2. The system of claim 1, wherein the processor comprises:
an input processing module configured to transform the user inputs into corresponding data inputs;
a natural language processing module configured to:
merge one or more of the plurality of modalities of user input from the data;
identify keywords in the user inputs from the data;
identify user intent, context, and sentiment based on the identified keywords; and
a dialog management module configured to:
identify one or more topics relevant to the user inputs based on information received from the natural language processing module; and
manage dialog flows.

3. The system of claim 2, wherein the input processing module comprises a speech recognition engine for processing audio input from the user, a text capture engine for processing text input from the user, and a visual analysis engine for processing video and images input from the user.

4. The system of claim 1, further comprising a modality focus listener configured to monitor user inputs and the generated output, to distinguish the plurality of modalities of user input, to identify active modalities of input, and to prioritize user inputs from active modality.

5. The system of claim 1, further comprising a context management module configured to provide a unified conversation context derived from the plurality of modalities of user inputs and generated responses.

6. The system of claim 5, wherein the context management module provides the unified conversation context by capturing and storing snapshots of the conversation.

7. The system of claim 5, wherein the natural language processing module identifies user intent by extracting keywords from user input and retrieving the unified conversation context from the context management module.

8. The system of claim 1, wherein the plurality of modalities of user input comprises voice, written text, captured audio data, captured visual data, and any combination thereof.

9. The system of claim 8, wherein the captured visual data comprises QR codes, scanned documents, screenshots, images, and videos.

10. The system of claim 1, wherein the plurality of modalities of output comprises voice, written text, audio data, visual data, and any combination thereof.

11. The system of claim 1, wherein the plurality of modalities of user input are provided on a user interface communicatively coupled to the system and wherein the plurality of modalities of generated output are provided to a user on the user interface.

12. The system of claim 1, further comprising a call management platform facilitating handling of multiple inbound calls from users.

13. The system of claim 1, further comprising a control center circuit configured to synchronize the plurality of modalities of user input and plurality of modalities of generated output.

14. The system of claim 13, wherein the control center circuit is further configured to track the synchronization of the plurality of modalities of user input and plurality of modalities of generated output throughout a user session.

15. The system of claim 14, wherein the control center circuit employs intelligent tracking identifiers comprising one or more of session, call connection, page number, section number, current question, or previous question, to manage points along the conversation.

16. The system of claim 1, further comprising an agent circuit configured to interact with the user and comprising a plurality of task agents to handle corresponding specialized tasks.

17. The system of claim 1, further comprising a session manager configured to establish and maintain user sessions, wherein the session manager maintains state and context of conversations across multiple interactions, thereby providing coherent and contextually relevant responses over the course of a user session.

18. The system of claim 17, wherein the session manager is further configured to break user inputs into tasks assigned to task agents specialized to handle respective tasks, and wherein the session manager is further configured to implement fact-checking to ensure that responses generated by task agents are accurate.

19. The system of claim 17, wherein the session manager is further configured to track context of user conversations through tracking and storing session metadata.

20. The system of claim 17, wherein the session metadata comprises one or more of user information, user inputs, user input device, call connection, conversation page number, conversation section number, current question, previous questions, user preferences, task status, task agent responses to user inputs.

21. A method of operating a multimodal conversational AI system, the method comprising:
defining, with a dialog management module, a plurality of topics and associated dialog flows;
establishing, using the session manager, a user session;
initiating a conversation with the user with the session manager;
receiving, by the user interface, a plurality of modalities of user input;
processing, with an input processing module comprising one or more computing processors, the plurality of modalities of user input;
updating, with the context management module, a unified conversation context based on each processed user input;
dynamically generating, with the multimodal response generator, at least one immersive multimodal response tailored to at least one of a plurality of output modalities; and
delivering each multimodal response to the user via a plurality of modalities of output.

22. The method of claim 21, further comprising tracking the active modality of the plurality of modalities of user input and the plurality of output modalities.

23. The method of claim 22, wherein defining a plurality of topics and dialog flows comprises providing a list of predefined topics and dialog flows and fetching topic-specific data from user input and online sources.

24. The method of claim 23, wherein establishing a user session comprises receiving a call from a user and determining a user identity.

25. The method of claim 24, wherein initiating a conversation comprises delivering a predefined output to the user thereby prompting the user to provide user input.

26. The method of claim 25, wherein the plurality of modalities of user input comprises voice, written text, captured audio data, captured visual data, and any combination thereof.

27. The method of claim 26, wherein processing user input comprises identifying keywords and determining user intent and sentiment.

28. The method of claim 27, wherein updating the unified conversation context comprises capturing and storing snapshots of the conversation, wherein the snapshot comprises the active modality, user input, and generated output.

29. The method of claim 28, wherein generating a multimodal response comprises generating a plurality of modalities of generated output based on the unified conversation context and dialog flows.

30. The method of claim 29, wherein the plurality of modalities of output comprises voice, written text, audio data, visual data, and any combination thereof.

31. The method of claim 30, further comprising summarizing the user session, storing the session summary, and delivering the session summary to the user.
